(19) United States
(12) Patent Application Publication
(10) Pub. No.: US 2010/0016106 A1
(43) Pub. Date: Jan. 21, 2010

(54) BELT DRIVING APPARATUS AND RECORDING APPARATUS

(75) Inventor: Hidefumi MINEMURA, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/503,666

(22) Filed: Jul. 15, 2009

(30) Foreign Application Priority Data
Jul. 16, 2008 (JP) 2008-184641

(51) Int. Cl. F16H 7/02; F16H 7/18; F16H 7/08; B41J 23/02

(52) U.S. Cl. 474/113; 400/185

(57) ABSTRACT

A belt driving apparatus includes: a drive pulley that is attached to an output shaft of a drive motor and has teeth formed on the outer peripheral surface thereof; a driven pulley that is spaced apart from the drive pulley; an endless belt that is wound between the drive pulley and the driven pulley and is configured of a timing belt; a tension pulley that is provided on an upstream side in the vicinity of the drive pulley and comes in contact with the outer peripheral surface of the endless belt on an upstream side to apply tension to the endless belt; and a winding angle maintaining member that is provided on a downstream side in the vicinity of the drive pulley and on the side of the outer peripheral surface of the belt to maintain the winding angle of the endless belt with respect to the drive pulley.

### BACKGROUND

1. Technical Field

The present invention relates to a belt driving apparatus that includes a drive pulley that is attached to an output shaft of a drive motor and has teeth formed on the outer peripheral surface thereof; a driven pulley that is spaced apart from the drive pulley and has teeth formed on the outer peripheral surface thereof; an endless belt that is wound between the drive pulley and the driven pulley and is a timing belt having teeth on the inner peripheral surface thereof; and a tension pulley that is provided on an upstream side of the drive pulley in the vicinity of the drive pulley and comes in contact with the outer peripheral surface of the endless belt on an upstream side of the endless belt to apply tension to the endless belt; and a recording apparatus, such as a facsimile machine or a copying machine, which includes the belt driving apparatus.

2. Related Art

Hereinafter, an inkjet printer will be described as an example of a recording apparatus. The inkjet printer includes a transport apparatus for a recording medium that includes a transport roller unit having a drive transport roller and a driven transport roller for transporting a recording medium such as paper to a recording region and a discharge roller unit having a drive discharge roller and a driven discharge roller for discharging the recording medium to the outside of the body of the apparatus after the recording operation. The belt driving apparatus as disclosed in JP-A-2006-77900 and JP-A-2004-123381 are being used as a power transmitting apparatus to the drive transport roller and the drive discharge roller.

JP-A-2006-77900 discloses a belt driving apparatus in which only one driven pulley is rotated by one drive motor. Since only one driven pulley is provided in the belt driving apparatus, the winding angle of an endless belt with respect to a drive pulley can increase, thereby enabling stable transport of the endless belt without causing tooth jumping even when the initial tension of a tension pulley is set to be small.

Meanwhile, JP-A-2004-123381 discloses a belt driving apparatus in which two driven pulleys are rotated by one drive motor. The two driven pulleys are synchronously rotated without provision for any complex gear wheel row.

However, the belt driving apparatus of JP-A-2006-77900 has only one driven pulley that can be driven by one drive motor, and the number of driven pulleys is limited. Therefore, when power is transmitted to a plurality of drive shafts, a separate power transmitting apparatus such as a gear wheel row is necessary.

Meanwhile, in the belt driving apparatus 101 of JP-A-2004-123381, as illustrated in FIG. 10A, the winding angle θ of the endless belt 107 wound on the drive pulley 105 is large when the drive motor 103 is rotated forward, preventing tooth jumping and thereby properly transporting the endless belt 107. However, as illustrated in FIG. 10B, when the drive motor 103 rotating forward is reversed or the stopped drive motor 103 is rapidly reversed, the winding angle θ of the endless belt 107 is reduced to θ1 due to movement of the tension pulley 109 to a compression direction C and the loosening of the endless belt 107 on a downstream side of the drive pulley 105, causing the endless belt 107 to tooth jump and thereby hampering proper transport of the endless belt 107.

Although the reduction in the winding angle θ increases the initial tension of the endless belt 107 by the adjusting the application position of the tension pulley 109 and therefore can be improved a little, the load applied to the drive motor 103 also increases in order to rotate the driven pulley 111, thus hampering proper drive and control of the drive motor 103. Therefore, it is necessary to increase the power required for driving the drive motor 103 and increase the tooth length of the endless belt 107 which results in a louder sound being produced when the endless belt is transported.

### SUMMARY

An advantage of some aspects of the invention is that it provides a belt driving apparatus that reduces the possibility of tooth jumping by securing a winding angle of an endless belt necessary for a drive pulley regardless of conversion of the rotational direction of a drive motor or a start operation from a stationary state to a rapid reverse direction, and a recording apparatus including the belt driving apparatus.

According to a first aspect of the invention, there is provided a belt driving apparatus including: a drive motor that rotates forward and backward; a drive pulley that is attached to an output shaft of the drive motor and has teeth formed on the outer peripheral surface thereof; a driven pulley that is spaced apart from the drive pulley and has teeth formed on the outer peripheral surface thereof; an endless belt that is wound between the drive pulley and the driven pulley and is configured of a timing belt having teeth on the inner peripheral surface thereof; a tension pulley that is provided on an upstream side in the vicinity of the drive pulley and comes in contact with the outer peripheral surface of the endless belt on an upstream side to apply tension to the endless belt; and a winding angle maintaining member that is provided on a downstream side in the vicinity of the drive pulley and on the side of the outer peripheral surface of the belt to maintain the winding angle of the endless belt with respect to the drive pulley.

According to the first aspect of the invention, since the winding angle maintaining member for maintaining the winding angle of the endless belt with respect to the drive pulley is provided in the vicinity of the drive pulley on a downstream side, a change in the winding angle of the endless belt with respect to the drive pulley is prevented even when the rotational direction of the drive motor is converted or the stopped drive motor is rapidly rotated backward. Therefore, even when the initial tension of the endless belt by the tension pulley is reduced, the endless belt can be transported properly without causing tooth jumping, thereby decreasing the load applied to an output shaft of the drive motor and enabling the drive motor to be properly driven and controlled.

Specifically, high acceleration/deceleration control of the endless belt and high-precision transport to a high degree can be obtained and the drive motor can be driven at a low power. In addition, the teeth of the endless belt can be made smaller and the transport sound of the endless belt can be reduced, thereby enabling more precise feeding of the endless belt.

According to a second aspect of the invention, in the belt driving apparatus according to the first aspect, the winding angle maintaining member includes a convex portion integrally formed with a tension holder maintaining the tension pulley and the convex portion being formed such that a surface of the convex portion opposite to the drive pulley is located on the circumference of a circle whose center is a swing reference shaft that functions as a reference when determining the attachment position of the tension holder.

According to the second aspect of the invention, when the initial tension of the endless belt is set by adjusting the application position of the tension pulley, and since an aperture between the contact point of the convex portion and the outer peripheral surface of the drive pulley can become constant even if the tension holder is swung about the swing reference shaft, adjustment of the attachment position of the tension pulley can be devoted without considering the application position of the convex portion with respect to the endless belt.

According to a third aspect of the invention, in the belt driving apparatus according to the first aspect, the winding angle maintaining member is formed such that a surface of the winding angle maintaining member opposite to the outer peripheral surface of the endless belt has a guide shape in a general state along the path of the endless belt at a withdrawal position where the endless belt wound on the drive pulley is far away from the drive pulley.

According to the third aspect of the invention, since the winding angle maintaining member is formed such that a surface of the winding angle maintaining member opposite to the outer peripheral surface of the endless belt has a guide shape along the path of the endless belt at a withdrawal position where the endless belt wound on the drive pulley is at a large distance from the drive pulley, the endless belt can be maintained in a wide range, thereby making the winding angle of the endless belt with respect to the drive pulley more stable and realizing proper transport of the endless belt.

According to a fourth aspect of the invention, in the belt driving apparatus according to the first aspect, the winding angle maintaining member has another tension pulley that applies tension to the endless belt by making contact with the outer peripheral surface of the endless belt on a downstream side.

According to the fourth aspect of the invention, in addition to an increase in the winding angle of the endless belt with respect to the drive pulley, since a change in the tension of the endless belt can be absorbed by the cushion operation due to the urging force of a tension pulley similar to the tension pulley installed on the upstream side of the drive pulley, thereby realizing smooth transport of the endless belt with a greater pursuing degree.

According to a fifth aspect of the invention, there is provided a recording apparatus including: a transport drive roller that applies a transport force toward a recording region to a recording medium; a discharge drive roller that applies a transport force toward a discharge direction to the recording medium; a belt driver that transmits forward and backward power to a roller driving shaft of the transport drive roller and a roller driving shaft of the discharge drive roller; and a recorder that performs a desired recording operation on the recording medium transported to the recording region. The belt driver is a belt driving apparatus according to any one of the first to fourth aspect.

The fifth aspect of the invention can show the same operations and effects as the first to fourth aspects of the invention. A single drive motor drives a transport drive roller and a discharge drive roller, thereby enabling smooth and precise transport in the transport direction and the return direction of the recording medium and additionally enhancing the recording quality of the recording apparatus.

### BRIEF DESCRIPTION OF THE DRAWINGS

The invention will be described with reference to the accompanying drawings, wherein like numbers reference like elements.

FIG. 1 is a perspective view of the internal structure of an inkjet printer.

FIG. 2 is a perspective view of a transport apparatus for a recording medium.

FIG. 3 is a side view of a belt driving apparatus according to an embodiment of the invention.

FIG. 4 is a side view of a forward rotation of the belt driving apparatus according to the embodiment of the invention.

FIG. 5 is a side view of a backward rotation of the belt driving apparatus according to the embodiment of the invention.

FIG. 6 is an enlarged perspective view of the vicinity of a drive pulley of the belt driving apparatus according to the embodiment of the invention.

FIG. 7 is a side view of a belt driving apparatus according to another embodiment of the invention.

FIG. 8 is a side view of a belt driving apparatus according to still another embodiment of the invention.

FIG. 9 is a side view of a belt driving apparatus according to yet another embodiment of the invention.

FIGS. 10A and 10B are side views of a forward rotation and a backward rotation of an existing belt driving apparatus.

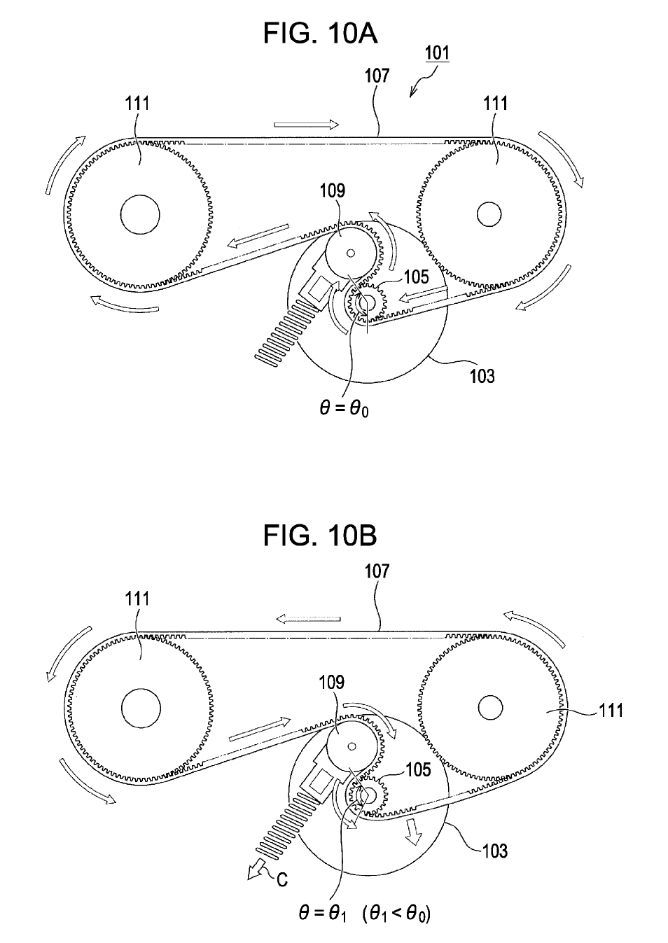

FIG. 11 is a side view of a modification of the belt driving apparatus of FIG. 4 in which a belt is stopped.

FIG. 12 is a view of a main portion of the belt driving apparatus to explain a method of determining an aperture of a contact point.

FIG. 13 is a side view of a tooth length Hp of a drive pulley and a tooth length Hb of an endless belt.

### DESCRIPTION OF EXEMPLARY EMBODIMENTS

Hereinafter, a belt driving apparatus and a recording apparatus that applies the belt driving apparatus as a power transmitting apparatus to a drive transport roller and a drive discharge roller according to the invention will be described. An inkjet printer 1 is employed as the best embodiment for realizing the recording apparatus first, and the schematic structure of the entire inkjet printer 1 will be described with reference to the accompanying drawings.

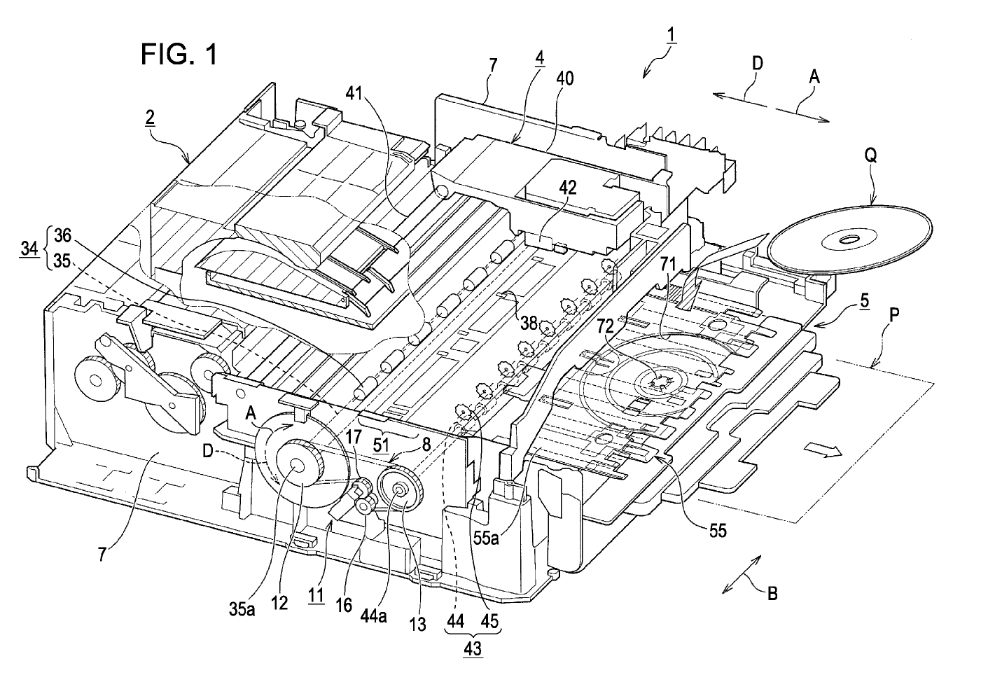

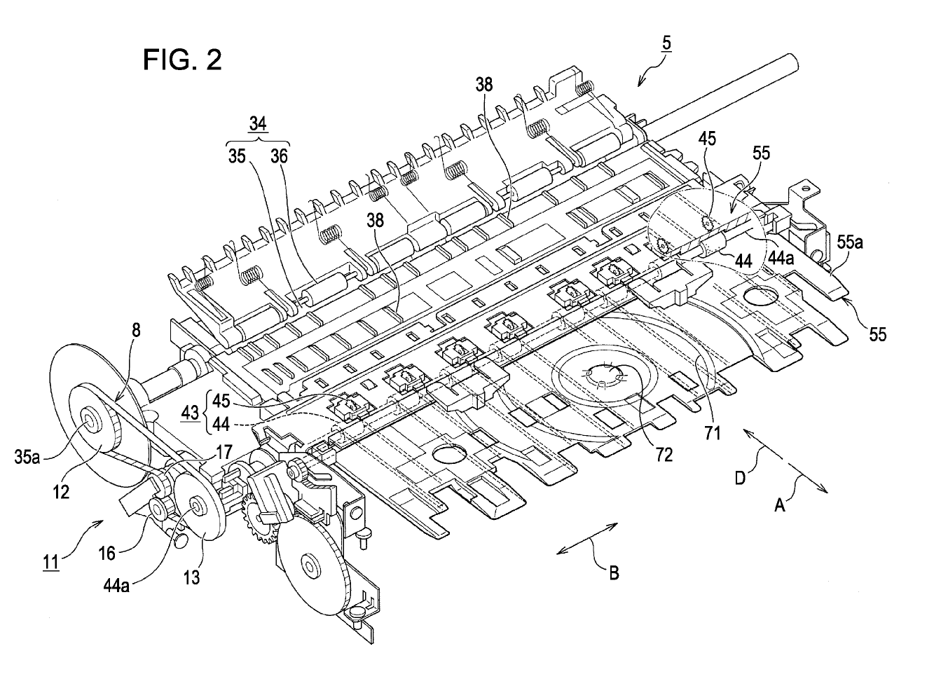

FIG. 1 is a perspective view of the internal structure of an inkjet printer. FIG. 2 is a perspective view of a transport apparatus for a recording medium. The illustrated inkjet printer 1 is a complex inkjet printer onto which an image reading apparatus (scanner) (not shown) is mounted, and is of a type that can perform a recording operation on both a soft recording medium P such as paper or a film and a hard recording medium Q such as an optical disk including CD-R or DVD-R.

The inkjet printer 1 includes a printer body 2 that has a rectangular box shape and whose appearance has a relatively flat surface. A transport apparatus 5 that transports the soft recording medium P and the hard recording medium Q toward a recording region 51 and discharges the recording mediums P and Q to the outside of the printer body 2 after the recording operation and a recording apparatus 4 that performs a recording operation on the recording mediums P and Q transported to the recording region 51 are installed inside the printer body 2.

The illustrated transport apparatus 5 for the recording mediums includes a maintenance tray 55 used when a recording operation is performed on the hard recording medium Q, a transport roller unit 34 having a drive transport roller 35 and a driven transport roller 36 that transport two types of recording mediums P and Q toward the recording region 51 and discharge the recording mediums P and Q on which a recording operation has been performed to the outside (the front side in the embodiment of the invention) of the printer body 2, a discharge roller unit 43 having a drive discharge roller 44 and a driven discharge roller 45, and a below-described belt driving apparatus 11 according to the present invention that transmits power to a roller driving shaft 35a of the drive transport roller 35 and a roller driving shaft 44a of the drive discharge roller 44 in a forward direction A (the same reference symbol A as the transport direction is used) and in a backward direction D (the same reference symbol D as the return direction is used).

In the embodiment of the invention, the maintenance tray 55 is constituted by a rectangular plate-like member having a shallow inner depth, and has a set block 71 for setting a hard recording medium Q and a chuck 72 installed on its top surface 55a.

The transport roller unit 34 includes a long drive transport roller 35 extending in a widthwise direction B and a plurality of short driven transport rollers 36 pressed by the outer peripheral surface of the drive transport roller 35 and installed at suitable intervals along the widthwise direction B. The transport side driven pulley 12 of the belt driving apparatus 11 mounted on a roller driving shaft 35a of the drive transport roller 35 and the discharge side driven pulley 13 of the belt driving apparatus 11 are provided outside the left side frame 7.

The discharge roller unit 43 includes a plurality of drive discharge rollers 44 that are short rubber rollers installed at suitable intervals along the widthwise direction B on the roller driving shaft 44a, which extends horizontally between the right and left side frames 7 in the printer body 2, and a plurality of driven discharge rollers 45 each of which forms a pair with the corresponding drive discharge roller 44 and are disk-shaped tooth rollers. The driven pulley 13 on the discharge side of the belt driving apparatus 11 that is mounted on a roller driving shaft 44a is provided outside the left side frame 7.

The recording apparatus 4 basically includes a carriage 40 provided on the recording region 51, a recording head 42 mounted to the bottom surface of the carriage 40, and a platen 38 provided under the recording region 51. The carriage 40 is a member that can be reciprocally moved along a carriage guide shaft 41 which is built along the widthwise direction B crossing the transport direction A of the recording mediums P and Q, and a recording operation is performed as the ink supplied from an ink supply (not shown) to the recording head 42 is discharged onto the top surfaces of the recording mediums P and Q in correspondence to the reciprocal movement of the carriage 40.

The platen 38 is a rib-shaped member extending along the transport direction A, and guides the recording mediums P and Q with a constant gap being maintained between the ink discharge surface of the bottom surface of the recording head 42 and the recording mediums P and Q by supporting the bottom surface of the soft recording medium P transported into the recording region 51.

### First Embodiment

Hereinafter, the structure of a belt driving apparatus 11 that can be applied as a power transmitting apparatus in the transport apparatus 5 for a recording medium of the inkjet printer 1 according to an embodiment of the invention will be described in detail with reference to the accompanying drawings below. In the specification, an upstream side of the drive pulley 16 means an “upstream side” of the drive pulley 16 along the transport direction of the endless belt 8 when the drive motor 14 is rotated in the backward direction D, and a “downstream side” of the drive pulley 16 means a downstream side of the drive pulley 16 along the transport direction of the endless belt 8 when the drive motor 14 is rotated forward.

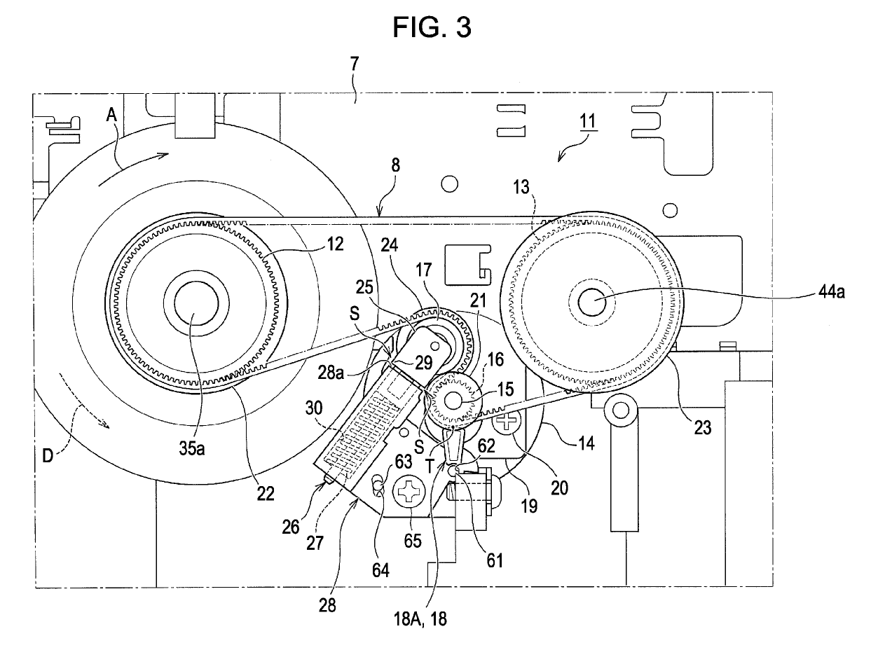

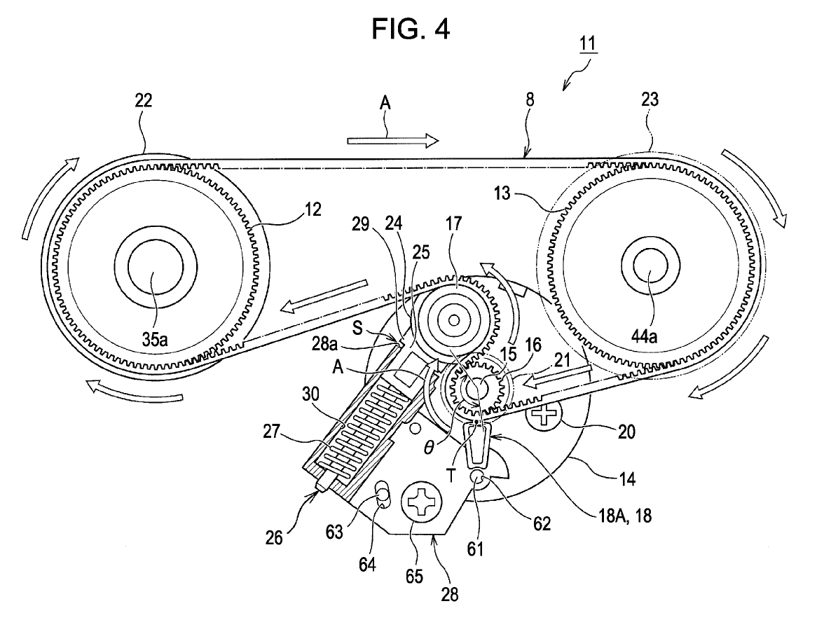

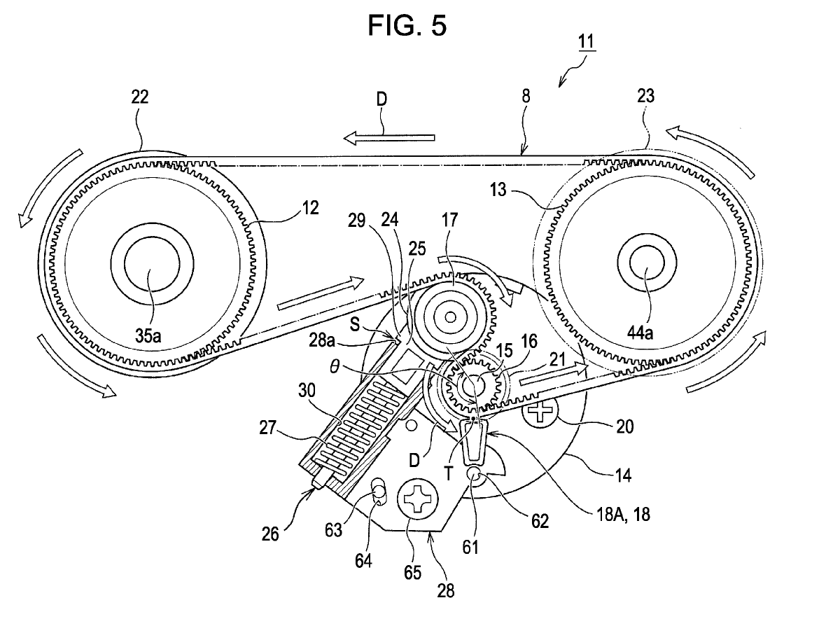

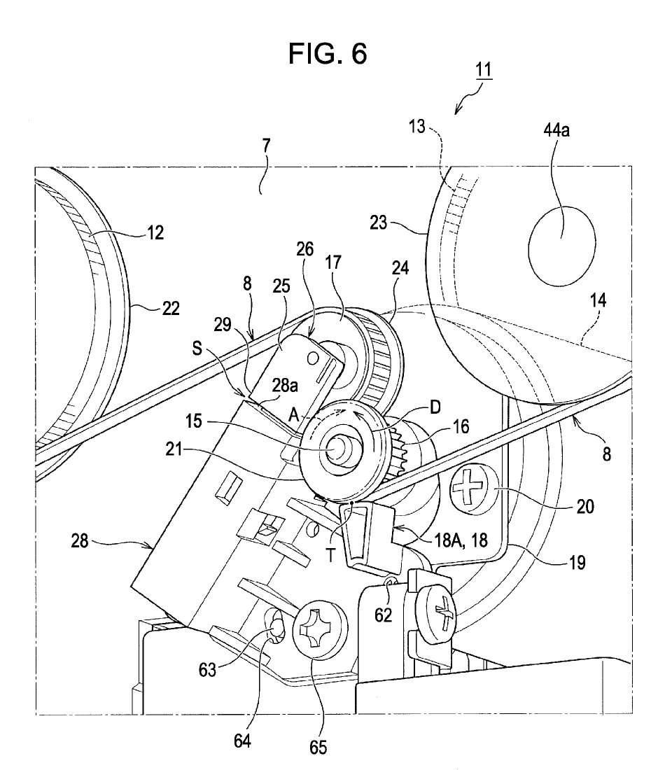

FIG. 3 is a side view of a belt driving apparatus disposed in the outer region of the side frame of the inkjet printer according to an embodiment of the invention. FIG. 4 is a side view of a forward rotation of the belt driving apparatus according to the embodiment of the invention. FIG. 5 is a side view of a backward rotation of the belt driving apparatus according to the embodiment of the invention. FIG. 6 is an enlarged perspective view of the vicinity of a drive pulley of the belt driving apparatus according to the embodiment of the invention.

The belt driving apparatus according to the embodiment of the invention includes a drive motor 14 that can be rotated in the forward direction A and in the backward direction D, a drive pulley 16 attached to an output shaft 15 of the drive motor 14, driven pulleys 12 and 13 spaced apart from the drive pulley 16, an endless belt 8 wound between the drive pulley 16 and the driven pulleys 12 and 13, a tension pulley 17 provided on an upstream side of the drive pulley 16 in the vicinity of the drive pulley 16 to apply a tension to the endless belt 8, and a winding angle maintaining member 18 provided on a downstream side of the drive pulley 16 in the vicinity of the drive pulley 16 to maintain the winding angle θ of the endless belt 8 with respect to the drive pulley 16.

As illustrated in FIG. 3, an output shaft 15 of the drive motor 14 is attached to a motor bracket 19 integrally formed with the side frame 7 using two screws 20 (FIG. 3 illustrates only one screw 20) such that it faces outward. The drive pulley 16 is a small diameter timing pulley having a plurality of teeth formed on the outer peripheral surface thereof, and an outer flange 21 having a diameter larger than that of the outer peripheral surface on which the teeth are formed is formed on the drive pulley 16.

In the embodiment of the invention, two driven pulleys, i.e. the driven pulley 12 on the transport side and the driven pulley 13 on the discharge side are provided, and, as illustrated above, the driven pulley 12 on the transport side is attached to the left end of the roller driving shaft 35a of the drive transport roller 35 located on the upstream side of the transport direction A. The driven pulley 12 is a timing pulley having a diameter larger than that of the drive pulley 16, and a plurality of teeth having the same length and pitch as those of the drive pulley 16 are formed on the outer peripheral surface of the driven pulley 12 on the transport side. An inner flange 22 having a diameter larger than the outer peripheral surface of the driven pulley 12 on the transport side on which the teeth are formed is formed on the inner end side of the driven pulley 12.

The driven pulley 13 on the discharge side is a timing pulley having a diameter substantially the same as that of the driven pulley 12 on the transport side, and, as illustrated above, is attached to a left end of the roller driving shaft 44a of the driven discharge roller 44 located on the downstream side of the transport direction A. A drive pulley 16 and a plurality of teeth having the same length and pitch as those of the driven pulley 12 on the transport side are formed on the outer peripheral surface of the driven pulley 13 on the discharge side. An outer flange 23 having a diameter larger than that of the outer surface of the driven pulley 13 on which the teeth are formed is formed on the outer end side of the driven pulley 13 on the discharge side.

The endless belt 8 is a timing belt having a plurality of teeth formed on the inner surface thereof, the teeth of the timing belt having the same length and pitch as those of the drive pulley 16 and the two driven pulleys 12 and 13. The tension pulley 17 is a flat pulley having an outer diameter larger than that of the drive pulley 16, and an inner flange 24 having a diameter larger than that of the outer peripheral surface of the tension pulley 17 is formed on the inner end side of the tension pulley 17.

The pulleys 12, 13, 16, and 17 are arranged in the order of the tension pulley 17, the driven pulley 12 on the transport side, and the driven pulley 13 on the discharge side in the forward direction A of the endless belt 8 with reference to the drive pulley 16, and deviation of the pulleys 16, 17, 12, and 13 of the endless belt 8 is prevented by alternately disposing the inner flange 22 of the driven pulley 12 on the transport side and the outer flange 23 of the driven pulley 13 on the discharge side.

The one side flange structure in which the flanges of the pulleys 16, 17, 12, and 13 are provided on only one of the inner and outer sides makes splitting of molds unnecessary and enables easy manufacture of pulleys with precise roundness. Therefore, the drive of the belt driving apparatus 11 can be precisely controlled and costs associated with manufacturing the pulleys can be reduced.

The tension pulley 17 urges the endless belt 8 in a direction along which the winding angle θ is made larger with respect to the drive pulley 16. In more detail, the tension pulley 17 is rotatably supported by a support rod 26 having a bearing 25 at the tip end thereof, and the tension pulley 17 supported by the support rod 26 maintains an illustrated attachment angle such that it can appear and disappear due to a tension holder 28 by using a compression coil spring 27. The bearing 25 on the support rod 26 has a supported portion on the bottom surface thereof, and the aperture S between the supported portion 29 of the bearing 25 and the top end surface 28a of the tension holder 28 is set so as not to be zero, considering the minimum allowable value in the size clearances of parts and a change in the temperature of the environment. The spring constant of the compression coil spring 27 accommodated in the spring accommodating portion 30 of the tension holder 28 is set to continuously maintain a predetermined tension of the endless belt 8 even when the aperture amount S is an upper limit value.

The tension holder 28 has a reference hole 62 coupled to a swing reference shaft 61 provided in the motor bracket 19, a long guide hole 64 engaged with a swing guiding convex portion 63 provided in the motor bracket 19, an accommodation hole (not shown) accommodating a screw shaft of a fixing screw 65 screw-coupled to a screw hole (not shown) provided in the motor bracket 19, and a convex portion 18A, i.e. an example of a winding angle maintaining member 18 that is a characteristic structure of the present invention.

The convex portion 18A is a member integrally formed with the tension holder 28 and is disposed above the reference hole 62. The convex portion 18A is a fan-shaped plate member whose tip end surface is arc-shaped, and a contact point T that comes in direct contact with the outer peripheral surface of the endless belt 8 is located on a circumference whose center is the swing reference shaft 61 extending from the motor bracket 19. When the convex portion 18A is applied as the winding angle maintaining member 18, even though the tension holder 28 is swung about the swung reference shaft 61 when the initial tension of the endless belt 8 is set by adjusting the application position of the tension pulley 17, the aperture between the contact point T of the convex portion 18A and the outer peripheral surface of the drive pulley 16 remains constant, the application position of the convex portion 18A to the outer peripheral surface of the endless belt 8 does not need to be considered.

Hereinafter, the operation of the belt driving apparatus 11 according to the embodiment of the invention will be described in the cases of (1) a forward rotation of the drive motor 14, and (2) a backward rotation of the drive motor 14, respectively, based on the belt driving apparatus 11 of FIGS. 3 to 6.

### (1) The Case of a Forward Rotation of the Drive Motor (see FIG. 4)

When the drive motor 14 is rotated in the forward direction A, the endless belt 8 wound on the outer peripheral surface of the drive pulley 16 is continuously released toward the tension pulley 17 and the driven pulley 12 on the transport side and the endless belt 8 wound on the outer peripheral surface of the driven pulley 13 on the discharge side is wound on the outer peripheral surface of the drive pulley. Then, although reduction in the winding angle θ due to loosening of the endless belt 8 at the initial stage of rotation of the drive pulley 16 is concerned on an upstream side of the drive pulley 16, from which the endless belt 8 is continuously released from the drive pulley 16, since the loosening of the endless belt 8 is simultaneously absorbed by an urging force of the tension pulley 17 and the endless belt 8 remains taut, the winding angle θ is not reduced.

### (2) The Case of a Backward Rotation of the Drive Motor (see FIG. 5)

When the drive motor 14 is rotated in the backward direction D, the endless belt 8 wound on the outer peripheral surface of the drive pulley 16 is continuously released toward the driven pulley 13 on the discharge side and the driven pulley 12 on the transport side, and the endless belt 8 wound on the outer peripheral surface of the driven pulley 12 on the transport side is wound on the outer peripheral surface of the drive pulley 16 via the tension pulley 17. Then, the tension pulley 17 is pushed back on a downstream side of the drive pulley 16, where the endless belt 8 is continuously released from the drive pulley 16, when the direction of the drive pulley 16 is reversed from the forward direction to the backward direction or vice versa or the drive pulley 16 is abruptly operated from a stationary state, until the supported portion 29 of the bearing 25 comes in contact with the top end surface 28a of the tension holder 28. As a result, the endless belt 8 is loosened and reduction of the winding angle θ due to the loosening of the endless belt 8 occurs. However, in the embodiment of the invention, due to the convex portion 18a as the winding angle maintaining member 18, the winding angle θ is desirably maintained as the loosened amount of the endless belt 8 and is immediately discharged outside the winding region of the drive pulley 16. Therefore, tooth jumping due to the loosening of the endless belt 8 does not occur and the drive of the endless belt 8 can be precisely controlled.

The belt driving apparatus 11 according to the embodiment of the invention can remarkably reduce the initial tension existing in the endless belt, thereby reducing the length of the teeth and achieving the silent operation.

### Second Embodiment

The belt driving apparatus 11 and the recording apparatus 1 that applies the belt driving apparatus 11 as a power transmitting apparatus in a transport apparatus 5 for a recording medium basically have the above-described structures, but partial modifications and eliminations may be made without departing from the spirit or scope of the invention.

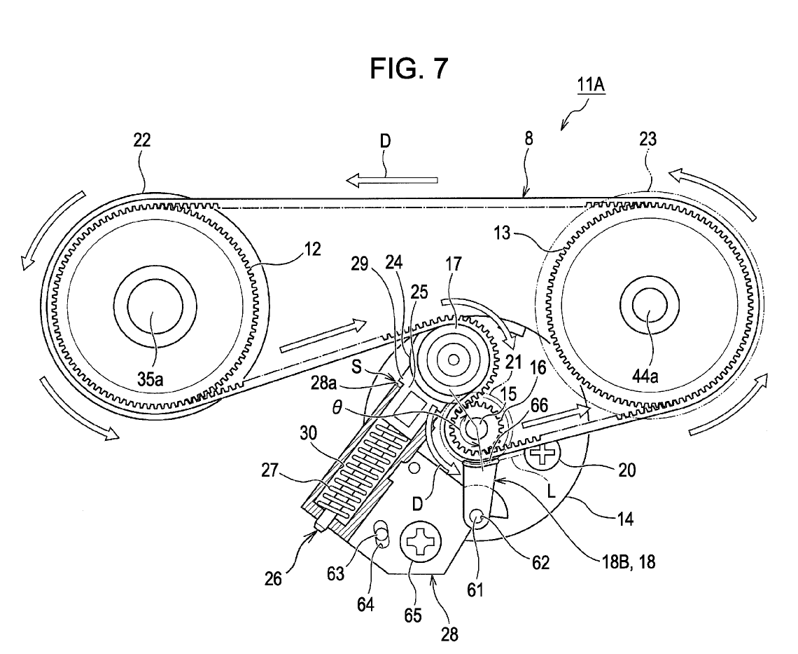

FIG. 7 is a side view of a belt driving apparatus where the configuration of the winding angle maintaining member is made different according to another embodiment of the invention. That is, as illustrated in the belt driving apparatus 11A in FIG. 7, the winding angle maintaining member 18 may have a guide member 18B as shown in the figure. The winding angle maintaining member 18 is formed such that a surface of the winding angle maintaining member 18 opposite to the outer peripheral surface of the endless belt 8 has a guide shape along the path of the endless belt 8 at a withdrawal position where the endless belt 8 wound on the drive pulley 16 is at a distance from the drive pulley 16 in a general state. That is, a maintenance application surface 66 applied to the outer peripheral surface of the endless belt 8, in a direction along the tangential line L between the drive pulley 16 and the endless belt 8, is located on the inner peripheral surface of the guide member 18B at a withdrawal position where the endless belt 8 is at a distance from the drive pulley 16 when the drive motor 14 is reversed.

Since the belt driving apparatus 11A having the guide member 18B can show the same operation and effect as the belt driving apparatus 11 of FIGS. 3 to 6 and the endless belt 8 is maintained in a wide range of the entire maintenance application surface 66 of the guide member 18, the winding angle θ of the endless belt 8 with respect to the drive pulley 16 can become more stable and properly transport the endless belt 8.

### Third Embodiment

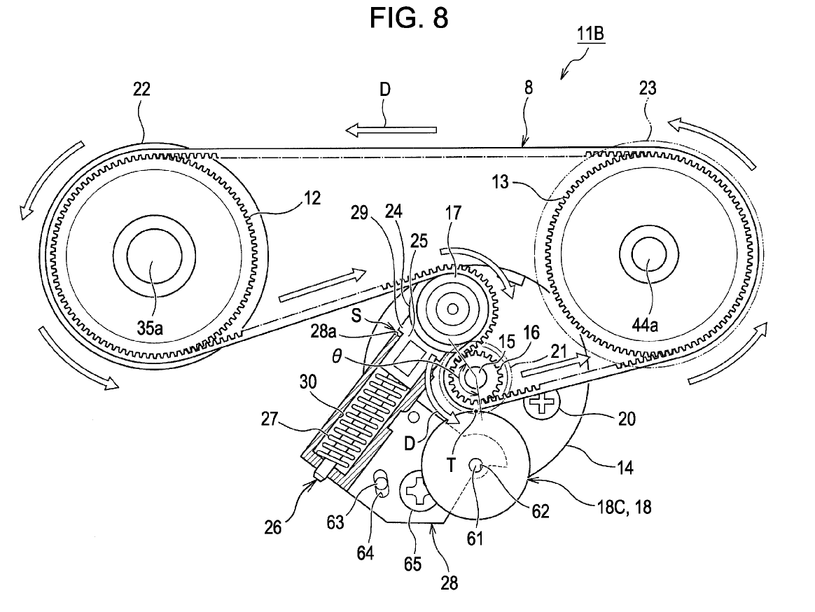

FIG. 8 is a side view of a belt driving apparatus where the configuration of the winding angle maintaining member is made different according to still another embodiment of the invention. As illustrated in the belt driving apparatus 11B of FIG. 8, the winding angle maintaining member 18 may have a guide pulley 18C. The guide pulley 18C is rotatably attached using a swing reference shaft 61 extending from the motor bracket 19 to the outside, has a contact point T on a circumference whose center is the swing reference shaft 61 as in the belt driving apparatus 11 of FIGS. 3 to 6, and an aperture between the outer peripheral surface of the drive pulley 16 and the contact point T is maintained constant regardless of the swing angle of the tension holder 28. The belt driving apparatus 11B having the guide pulley 18C can show the same operation and effect as the belt driving apparatus 11 of FIGS. 3 to 6.

### Fourth Embodiment

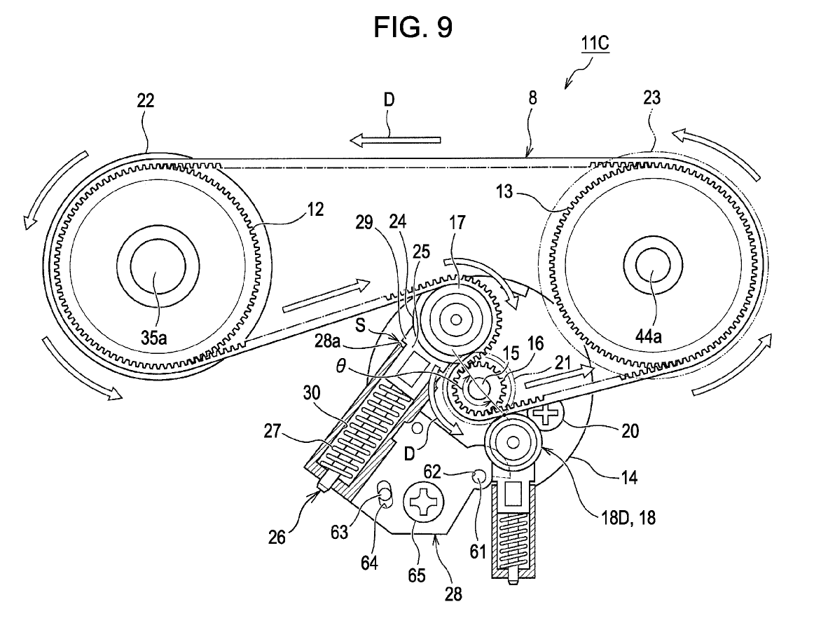

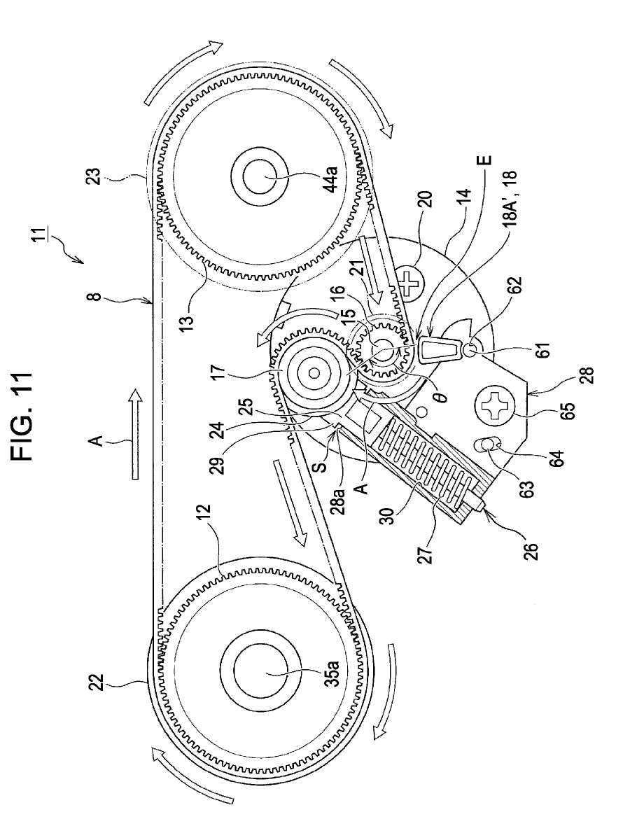

FIG. 9 is a side view of a belt driving apparatus that includes a winding angle maintaining member having a different structure according to yet another embodiment of the invention. As illustrated in FIG. 11C of FIG. 9, the winding angle maintaining member 18 may have another tension pulley 18D that applies a tension to the endless belt 8 by making contact with the outer peripheral surface of the endless belt 8. In the embodiment of the invention, since a tension pulley 17 and another tension pulley 18D are located in the vicinity of the drive pulley 16 on both an upstream side and a downstream side, the winding angle θ of the drive pulley 16 may increase. The belt driving apparatus 11C having another tension pulley 18D can show the same operation and effect as the belt driving apparatus 11 of FIGS. 3 to 6 and can cope with a rapid change in the tension of the endless belt 8 using the cushion operation of the two tension pulleys 17 and 18D.

In addition, the belt driving apparatus 11 of the present invention is not limited to a transport apparatus for a recording medium of the inkjet printer 1 and can be applied as a power transmitting apparatus for various machines that transmit power in the forward direction A and in the backward direction B between a plurality of shafts provided at positions where a drive pulley is spaced apart from a driven pulley. The number of the driven pulleys 12 and 13 is not limited to two and may be equal to or more than three. Further, one driven pulley is also possible.

### Fifth Embodiment

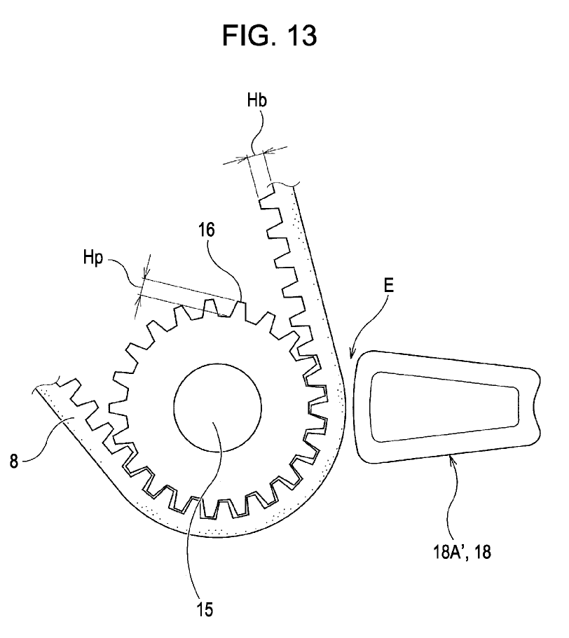

FIG. 11 is a side view illustrating a modification of the belt driving apparatus according to the embodiment of the invention when a belt is rotated forward. Although the convex portion 18A, i.e. the winding angle maintaining member 18, makes contact with the endless belt 8 almost all the time in the first embodiment of the present invention, a convex portion 18A′ opposes the endless belt 8 with an aperture E being therebetween when the belt is stopped or rotates forward and does not make contact with the endless belt 8. In the embodiment of the invention, the amount of the aperture E is set to be less than the smaller one of the tooth length Hp of the drive pulley 16 of FIG. 13 and the tooth length Hb of the endless belt 8.

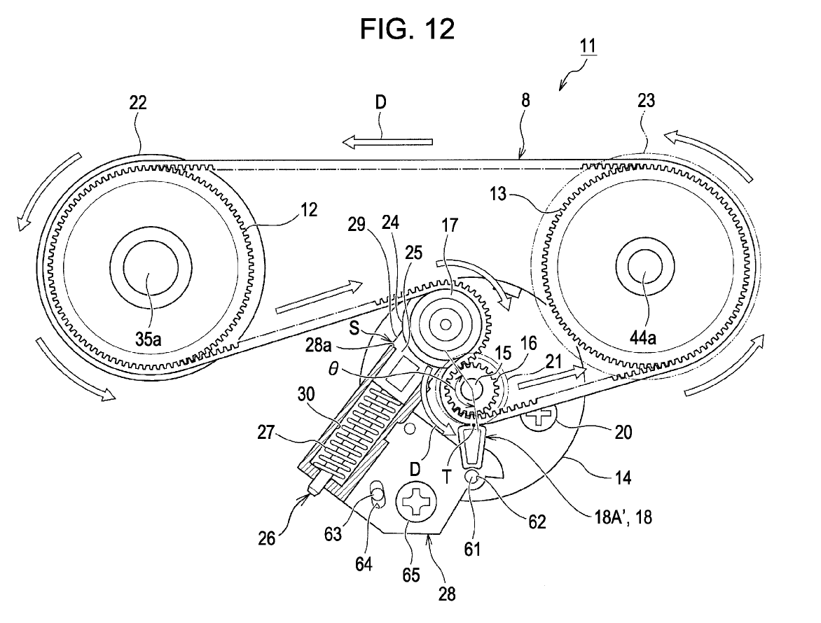

Hereinafter, the operation of the belt driving apparatus 11 according to the embodiment of the invention will be described in the cases of (1) a forward rotation of the drive motor 14, and (2) a backward rotation of the drive motor 14, respectively, based on the FIGS. 11 and 12.

### (1) The Case of a Forward Rotation of the Drive Motor (see FIG. 11)

When the drive motor 14 is rotated in the forward direction A, the endless belt 8 wound on the outer peripheral surface of the drive pulley 16 is continuously released toward the tension pulley 17 and the driven pulley on the transport side and the endless belt 8 wound on the outer peripheral surface of the driven pulley 13 on the discharge side is wound on the outer peripheral surface of the drive pulley. Then, although reduction in the winding angle θ due to loosening of the endless belt 8 at the initial stage of rotation of the drive pulley 16 is concerned on an upstream side of the drive pulley 16, from which the endless belt 8 is continuously released from the drive pulley 16, since the loosening of the endless belt 8 is simultaneously absorbed by an urging force of the tension pulley 17 and the endless belt 8 remains taut, the winding angle θ is not reduced.

When the belt is rotated forward, it needs to be driven and rotated at a high speed or at a high precision. According to the embodiment of the invention, when the belt is rotated forward (or is stopped), since the convex portion 18A′ opposes the endless belt 8 with an aperture E being therebetween and does not make contact with the endless belt 8, a contact-based frictional load is not applied to the endless belt 8. Therefore, the endless belt 8 can be stably driven and rotated at a high speed or at a high precision.

### (2) The Case of a Backward Rotation of the Drive Motor (see FIG. 12)

If the drive motor 14 starts to rotate in the backward direction D, the endless belt 8 wound on the outer peripheral surface of the drive pulley 16 is continuously released toward the driven pulley 13 on the discharge side and the driven pulley 12 on the transport side, and the endless belt 8 wound on the outer peripheral surface of the driven pulley 12 on the transport side is wound on the outer peripheral surface of the drive pulley 16 via the tension pulley 17. Then, the tension pulley 17 is pushed back again and moves until the supported portion 29 of the bearing 25 comes in contact with the top end surface 28a of the tension holder 28 on the downstream side of the drive pulley 16 where the endless belt 8 is continuously released from the drive pulley 16 when the direction of the drive pulley 16 is reversed or abruptly started from a stationary state, thereby loosening the endless belt 8 and reducing the winding angle θ due to this loosening of the endless belt 8. However, in the embodiment of the invention, due to the convex portion 18A′ as the winding angle maintaining member 18, even when the endless belt 8 is loosened, the endless belt 8 immediately comes in contact with the convex portion 18A′, stopping the loosening of the endless belt 8 thus maintaining the winding angle θ desirably. Therefore, tooth jumping due to the loosening of the endless belt 8 cannot occur and the endless belt 8 can be controlled and driven with high precision.

The belt driving apparatus 11 according to the embodiment of the invention can remarkably reduce the initial tension of the endless belt, thereby reducing the length of the teeth and achieving the silent operation.

What is claimed is:

1. A belt driving apparatus comprising:
a drive motor that rotates forward and backward;
a drive pulley that is attached to an output shaft of the drive motor and has teeth formed on the outer peripheral surface thereof;
a driven pulley that is spaced apart from the drive pulley and has teeth formed on the outer peripheral surface thereof;
an endless belt that is wound between the drive pulley and the driven pulley and is configured of a timing belt having teeth on the inner peripheral surface thereof;
a tension pulley that is provided on an upstream side in the vicinity of the drive pulley and comes in contact with the outer peripheral surface of the endless belt on an upstream side to apply tension to the endless belt; and
a winding angle maintaining member that is provided on a downstream side in the vicinity of the drive pulley and on the side of the outer peripheral surface of the belt to maintain the winding angle of the endless belt with respect to the drive pulley.

2. The belt driving apparatus according to claim 1, wherein the winding angle maintaining member includes a convex portion integrally formed with a tension holder maintaining the tension pulley and the convex portion being formed such that a surface of the convex portion opposite to the drive pulley is located on the circumference of a circle whose center is a swing reference shaft that functions as a reference when determining the attachment position of the tension holder.

3. The belt driving apparatus according to claim 1, wherein the winding angle maintaining member is formed such that a surface of the winding angle maintaining member opposite to the outer peripheral surface of the endless belt has a guide shape in a general state along the path of the endless belt at a withdrawal position where the endless belt wound on the drive pulley is far away from the drive pulley.

4. The belt driving apparatus according to claim 1, wherein the winding angle maintaining member has another tension pulley that applies tension to the endless belt by making contact with the outer peripheral surface of the endless belt on a downstream side.

5. A recording apparatus comprising:
a transport drive roller that applies a transport force toward a recording region to a recording medium;
a discharge drive roller that applies a transport force toward a discharge direction to the recording medium;
a belt driver that transmits forward and backward power to a roller driving shaft of the transport drive roller and a roller driving shaft of the discharge drive roller; and
a recorder that performs a desired recording operation on the recording medium transported to the recording region,
wherein the belt driver is a belt driving apparatus according to claim 1.
